(19) United States
(12) Patent Application Publication
(10) Pub. No.: US 2022/0339674 A1
(43) Pub. Date: Oct. 27, 2022

(54) APPARATUS AND METHOD FOR CLASSIFYING PARTS FOR SEPARATING OR SORTING A SET OF PARTS

(71) Applicant: Mario Urdaneta, Washington, DC (US)

(72) Inventor: Mario Urdaneta, Washington, DC (US)

(73) Assignee: MicroRecycling Systems LLC, Washington, DC (US)

(21) Appl. No.: 17/237,360

(22) Filed: Apr. 22, 2021

(51) Int. Cl. B07C 5/36; B07C 5/342

(52) U.S. Cl. CPC B07C 5/366; B07C 5/3425; B07C 2501/0054

(57) ABSTRACT

An apparatus and a method for separating or sorting parts are described. For example, an apparatus can include a fluidic section that comprises an input section. The fluidic section can be configured to receive a fluid including a plurality of parts at the input section. The fluidic section can be configured to receive the fluid at an inlet port of the fluidic section. The fluidic section can include at least two branches extending from the input section, and each of these at least two branches can have an outlet through which the fluid or part of the fluid can be routed. The apparatus can include a set of sensors configured to capture information about the plurality of parts in the fluidic section. The apparatus can further include a set of actuators configured to effect, based on the information, a change in a movement of a set of parts from the plurality of parts such that the set of parts is distributed via the fluid to at least one of the at least two branches.

### BACKGROUND

The present disclosure relates to an apparatus and to a method of use thereof for separating and/or sorting a set of parts. The background description provided herein is for the purpose of generally presenting the context of the disclosure. The work of the presently named inventor, to the extent it is described in this background section, as well as aspects of the description that may not otherwise qualify as prior art at the time of filing, are neither expressly nor impliedly admitted as prior art against the present disclosure.

Typical machines for sorting materials in the recycling industry separate parts of materials simultaneously as the parts are exposed to the effect that underpins the separation. These typical machines may feature electromagnets and Eddy current separators (for separating according to the material's response to electromagnetic fields), electrostatic separators (for separating according to whether the material is electrically conductive or not), and shake tables (for separating according to density).

These systems and their analogues have several disadvantages. They lack precision for discriminating material properties, so they sort on an “all-or-nothing” basis. For example, these machines may not be capable of differentiating between different types of non-ferrous metals or between different types of insulating materials, and to compensate for this low fidelity, industry supply chains are shaped to avoid combination of materials that in the real world are often used together because they are hard to separate and poison each other during reprocessing (e.g., steel and copper). Furthermore, these typical machines have difficulty in predicting the position of a material being sorted once it is affected by the forces that discriminate the material from other materials in the plurality of materials to be recycled. As such, the choice of a machine to use is based on size and separation fidelity, which is quite low.

Another disadvantage is that typical recycling systems are configured to process a large-volume of material (typically ranging from 1 ton/hour to 50 tons/hour). As such, they are inadequately large for single sources of waste (e.g., individual factories, or individual households) and thus they are used in centralized operations to where waste from many sources is brought. Lastly, typical recycling systems may be undesirable for people to be near them because of concerns about noise, vibration, or because they are large and unsightly. Another disadvantage is that they do not collect information about individual parts they separate; if information is collected, that information is about the whole set of parts (e.g., total weight of a batch that is processed).

Another type of machine used in the recycling industry to sort materials operate through “sensor-based sorting” and as such rely on sensors that provide information for deciding whether a piece of material is of interest, and activate an actuator (typically jets of air, but more recently also robotic arms with suction cups) to separate that particular piece of material. A common configuration for sensor-based systems has material parts traveling on a conveyor belt that suddenly ends such that the parts become airborne and land in one of two bins. Air nozzles near the end of the conveyor belt produce puffs of air that affect the part trajectory to make it land in its intended bin. Unfortunately, the unique geometry of each part translates into slightly different forces exerted by the puff of air on each part and this puts inherent limits on the sorting fidelity of this approach, even if the material is identified accurately by the sensors. The sensors typically include optical detectors (ranging in their sensitivity to light wavelengths from ultraviolet to infrared) or x-ray detectors for capturing x-ray fluorescence resulting from excitation by an x-ray source in the system, or for capturing x-rays that travel through the materials. Optical sensors are only able to capture information from the surface of the material and are thus prone to be confused by films covering the material (such as dirt, oil, or paint) and by fragments that have more than one material.

X-ray fluorescence sensors are very good at identifying the elements in a material, but only up to a certain depth (typically less than 1 mm) since x-ray fluorescence originating from atoms deeper in the material are absorbed by the material itself before they can leave it. Additionally, in order to identify the materials properly the system must gather enough fluorescence photons so as to generate a satisfactory material fingerprint and relatively few fluorescence photons are generated compared to the amount illuminated on the material (because of the inefficiencies of fluorescence as well as self-absorption of deeply-generated fluorescence). For example, hand-held x-ray fluorescence systems also used in the recycling industry (but not the focus of this invention) gather x-ray fluorescence for ˜1 minute before providing reliable material identification.

As a consequence, XRF-based sorting systems use very bright x-ray sources (which makes them hazardous and energy inefficient) in order to provide a strong fluorescence signal, and may also require relatively large sensing areas or move the material past the sensors slowly, such that the system has time to collect enough fluorescence x-rays.

X-ray absorbance systems have the advantage of collecting information through the entire depth of the material. However, x-ray absorbance systems used in the recycling industry focus on high-throughput of material, which means that the material being sorted can be several millimeters thick. As a consequence, such systems use high energy x-rays (i.e., 100 keV) in order for the x-rays to travel across the entire thickness of the material being sorted. High-energy x-rays require expensive sensors (e.g., scintillating crystals), heavy shielding around the sensing area, and are only able to discriminate coarsely according to atomic number because of tradeoffs in machine geometry, speed, and detection materials that have to be made to accommodate large processing capacity.

Furthermore, the attenuation of the x-rays will depend on the thickness of the material, not just the atomic composition, so an x-ray absorbance system may confuse low-Z/high-thickness with high-Z/low-thickness, thus requiring multi-sensor schemes to gain some degree of spectroscopic information.

Systems that rely on only one sensing modality or type of sensor, like the optical and x-ray sensor-based systems described before, are prone to being fooled by parts that have multiple materials, parts whose measured characteristics are at the boundary of the characteristics expected, parts whose characteristics are atypical to a group, but still part of that group, and parts that are cosmetically modified to look like materials they are not.

### SUMMARY

In view of the above-noted shortcomings in the industry, systems that rely on only one sensing modality are also prone to mistakes due to sensor measurement inaccuracies, such as sensing artifacts, limited dynamic range, signal noise, and other known limitations to a particular to a type of sensor or to all sensors in general. It is desirable to combine the information gathered by different modalities on each particular part in order to reduce the uncertainty of the determination. However, limited sensing modality options in the market place, the dominant position of sensor-less systems means, and other practical barriers stand in the way to combine information from each system about each part. It is more convenient if information from multiple sensors is gathered near-simultaneously from a single system that is also able to combine the information from all the sensors for a single analysis and determination. The embodiments featured herein provide one or more of such advantages, as shall be described below.

One or more embodiments of the present disclosure relate to sensing elemental composition or material properties with the purpose of identifying, sorting, separating, and/or extracting specific materials from a plurality of parts (or generally, particles). The elemental composition of a part in this disclosure refers to the defining atomic elements present in the part or the defining molecular structure of the part. For example, an embodiment as featured herein can be employed in a machine that is configured to sort small amounts of recyclable material according to elemental composition with high fidelity. By example, and without limitation, the sorting throughput may be less than about 400 pounds/hour (lbs./hr.).

According to an embodiment, there is provided an apparatus that includes a fluidic section comprising an input section. The fluidic section may be configured to receive a fluid including a plurality of parts at the input section. The fluidic section may include at least two branches extending from the input section. The apparatus may include a set of sensors configured to capture information about the plurality of parts in the fluidic section. The information from the set of sensors is analyzed along with other relevant and background information to make determinations about parts, likely volume, likely mass, likely shape, likely composition and proportion, and other characteristics of interest. The part identity refers to the equivalent term in the trade for different scrap materials (e.g., Twitch, which is a grade of aluminum scrap), or general identifiers, like “red HDPE”. The apparatus may further include a set of actuators configured to effect, based on the information analysis, a change in a movement of a set of parts from the plurality of parts such that the set of parts is distributed via the fluid to at least one of the at least two branches.

### BRIEF DESCRIPTION OF THE DRAWINGS

FIG. 1 illustrates an apparatus or system according to various aspects described herein.

FIG. 2 depicts a flow chart of a method according to various aspects described herein.

FIG. 3 illustrates a system according to various aspects described herein.

FIG. 4 illustrates a system according to various aspects described herein.

FIG. 5 depicts a graph of information about parts captured by an apparatus according to various aspects described herein.

FIG. 6 depicts a photograph of electromagnetic coils used in capturing information about parts by an apparatus according to various aspects described herein.

FIG. 7 depicts a graph of information about a part captured by an apparatus according to various aspects described herein. The part is a steel screw.

FIG. 8 depicts a graph of optical absorbance as a function of light wavelength for different materials discussed herein.

FIG. 9 depicts a graph of information about parts captured by an apparatus according to various aspects described herein.

FIG. 10 depicts a photograph of a controller unit, signal conditioning, and other elements described herein.

FIG. 11 depicts a photograph of a graphical output by the controller unit summarizing determinations processed by an apparatus according to various aspects described herein.

FIG. 12 depicts a photograph of an apparatus according to various aspects described herein.

FIG. 13 depicts a photograph of parts before and after processing by an apparatus according to various aspects described herein.

### DETAILED DESCRIPTION

The following detailed descriptions are provided to assist the reader in gaining a comprehensive understanding of the methods, apparatuses, and/or systems described herein as well as modifications thereof. Accordingly, various modifications and equivalents of the methods, apparatuses, and/or systems described herein will be apparent to those of ordinary skill in the art. Descriptions of well-known functions and constructions may be omitted for increased clarity and conciseness.

Furthermore, the terms used herein are intended to describe embodiments only and shall by no means be restrictive. Unless clearly used otherwise, expressions in a singular form include a meaning of plural form. An expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

As previously stated, typical sorting technologies have low separation fidelity for materials with similar properties, are considered “all or nothing”, and are inherently big in size.

In contrast to typical sorting technologies, the present disclosure features one or more embodiments that are able to differentiate between materials of different composition and sort them with precision. Additionally, in an exemplary embodiment, because the material is to be provided to the sorting system as small particles (for example, and not by limitation, as particles having their longest dimension being less than about 20 millimeters (mm)) the different groups of sorted material originating from assemblies of mixed materials will be more homogeneous (i.e., of higher purity) than the output of typical sorting systems, which would instead operate over the entire assembly and assign its classification based on the aggregate response of all materials in the assembly.

Furthermore, because in one or more embodiments featured herein, the plurality of parts to be sorted is dispersed in a fluid, no dust is generated during sorting. Moreover, in one or more embodiments, the dimensions of the fundamental unit cell in the machine where the sorting happens, or “sorting cell”, are much smaller than what is achievable in typical sorting systems and can route parts to a greater number of different bins. Therefore, with the one or more embodiments, it is possible to build sorting systems with small capacity and with commensurately small footprints that are practical for use in low-volume applications neglected by current (large-scale) systems.

As such, the embodiments in their structural implementations and in their associated methods of operation reflect a stark departure from legacy sorting technologies. For instance, an exemplary system as described herein can enable a degree of processing flexibility unparalleled by current systems, which rely on separate lines to separate different types of material, at much lower capital expenses. Thus, exemplary systems as described herein can be small enough to capture recyclable material that typical systems, and the supply chain designed around them, currently ignore and are ill-positioned to capture and process profitably. The one or more embodiments can provide high-fidelity and high-throughput sorting for low-volume applications, which can be, for example and not by limitation, about 400 lbs·kg/hr.

In one exemplary embodiment, the apparatus can include a small channel in which the particles to be sorted flow, one or more sensors that collect information on the composition of the particles, one processing using that gathers, analyzes, and stores information from the sensors, one or more bifurcations downstream from the sensors, actuators that control the flow in the channel and its bifurcations, and a control system that activates the actuators to control the flow in the channel based on information from the sensors such that particles of interest flow down specific channels in the bifurcation. The sensors in the channel can be of different types, such as optical (for light of wavelengths of about 300-10,000 nm, including polarized and unpolarized), electrical (for measuring electrical impedances), magnetic (to measure the electron spin resonance frequency), X-ray detector, or acoustic. A sensor as defined herein does not necessarily exclude an excitation source configured to produce a signal that interacts with the particles and then reaches and lead to a signal that can be read by a detector. For example, for an optical sensor, a light source and a detector for detecting light reflected from the particles may be part of the sensor. Several non-limiting embodiments are described further below with reference to the accompanying drawings.

Unlike established devices for sorting parts, the exemplary device described herein combines sensors with different modalities that capture information about individual parts, either instantaneous or over time. Additionally, the system described herein analyses the information to generate a determination or judgement about individual parts. The analysis considers past sensor information (labeled and unlabeled), parameters set by a user, information about the sensors, a priori knowledge about type of parts, and other information. Labeled sensor information refers to reference information about parts of known characteristics. Unlabeled sensor information refers to information on parts whose composition or determination has not been confirmed by external input (e.g., programmer or user).

In some embodiments of the invention a determination means identifying individual particles out of a set of possible identities, known to those skilled in the art of artificial intelligence as a “classification” problem. The invention can use labeled sensor data as a reference data set to inform the classification process, for example and without limitation, as a parameter set used for supervised learning in training artificial intelligence algorithms for their eventual use in clustering incoming sensor data into their corresponding classification.

The invention described herein also employs unlabeled data in its analysis. As an example of how this invention employs unlabeled data is by considering that there is a likely correlation between the composition of a present part compared to previous parts in the short term (e.g., from one part to the next), because parts of similar composition are likely to travel together. Another example is by considering user acceptance-by-omission of recent determinations. In other words, the system is able to learn from experience. These last two approaches can be considered Bayesian in nature, in the sense that they make use of prior information to identify the likelihood of an outcome for the current situation.

The invention described herein also employs parameters set by a user in its analysis. An example of how this is adopted by the invention is by the user informing the system about the part of the identity or composition of incoming parts, so as to label the parts and create entries to a customized reference. Another example is when the user desires to prioritize one type of material over others, or to lower the threshold of certain elements in the part to declare the part to be of interest. The invention described herein also employs information about the sensors, such as geometry, type of sensor, age, and operating conditions, to account for external factors that influence information gathered by the sensor. An example of how this is adopted by the invention is by changing signal conditioning parameters to compensate for excitation source ageing. A central purpose of the inventions disclosed herein, in addition to identification on parts, is deciding what bin to assign every given part. For this decision it is valuable to also have external information, for example and without limitation, current pricing information about parts and part mixtures,

In an example of how the aggregate of information about a part is more valuable than the same information fragmented across different systems, is when information from one sensor in a system with multiple sensing modalities is missing, faulty, or ill-behaved. In such a case, information from other sensors can still generate an educated guess by estimating a joint probability distribution over the different possibilities and reach a determination. The invention seeks to produce determinations whose uncertainty is lower than the combined uncertainties from each sensor modality. This process is known to those familiar in the art as “sensor fusion”, and lower uncertainty on the overall determination refers to a determination that is more complete, or more dependable, or that results from an emerging view made possible by the combination of information from different sensors.

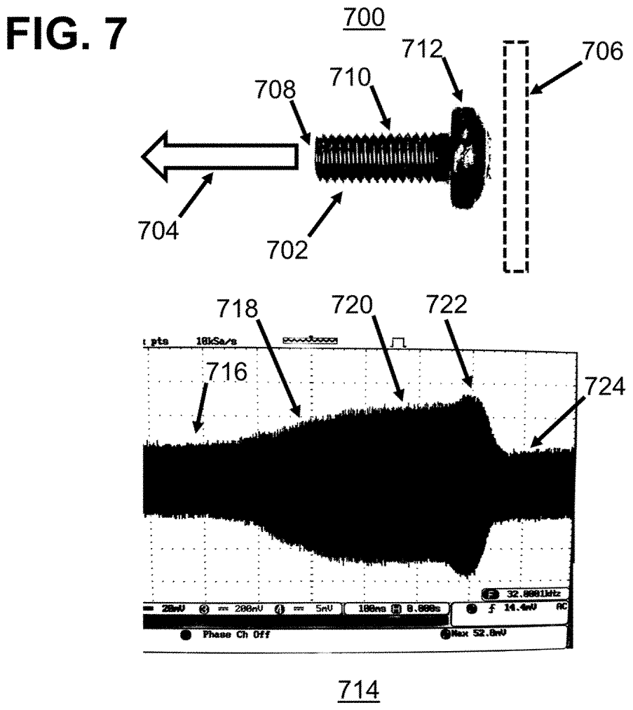

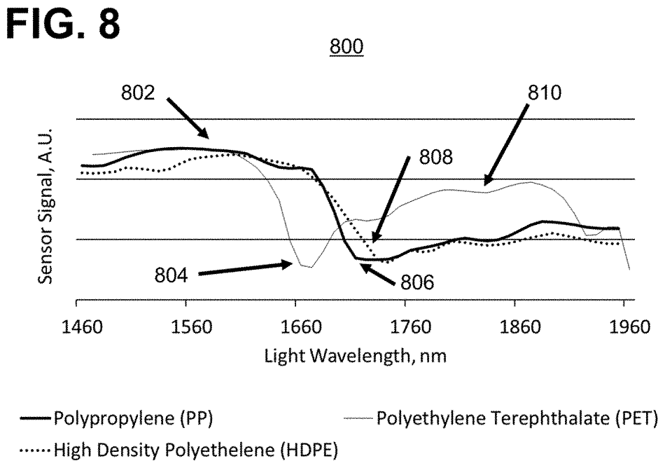

Another way in which the invention uses unlabeled information is by creating 2- or 3-dimensional representations of the parts. In an embodiment of the invention, one or more sensors gather information from a volume in space herein called “query plane”. Query plane is intersected by with the path of parts to be sensed, analyzed, and sorted by the system. As a given part moves past the query plane, the sensor output will change in a way that correlates, via the velocity of the part, with positions within the part. This is shown in the example given in FIG. 7, where the shape of the output 714 of an electromagnetic sensor over time resembles the shape of a part 702 that moved across the query plane. The fidelity of representations built using this method is influenced by the ability of sensor 706 to confine its sensing region to a narrow volume with minimal fringing sensing, because the output of 706 is in effect a lumped value corresponding to this entire sensing volume different features within this volume will be blurred together by the convolution of the part and the sensing volume. Signal 714 by sensor 706 shows effects of such blurring, as evidenced by an increasing slope in region 720 as a wider part 712 of the screw 702 approaches. The query plane will preferably approximate a two-dimensional plane, but in most cases will be a volume. In the case of electromagnetic coils as those shown in FIG. 8, employed in an induction balance configuration for detecting ferromagnetic materials, the signal is theoretically expected to change away from the coil axis as the diameter of the coil raised to the power of −3, i.e., coil diameter\hat{ }−3.

One way in which 2- or 3-dimensional representations of a given part is useful is in the case of sorting fragments of printed circuit board, which typically contain a range of metals. The 3D RF representation of an aluminum heatsink will be different from that of a copper ground plane, even as both can only be identified as non-ferrous based on a static signal alone. In this example the shape of the representation informs the determination that one fragment is likely copper and the other is likely aluminum. Since these metals are only valuable if kept apart, it is of economic interest to consider the structure of the part in determinations.

Parts are expected to move past sensors at speeds in the range of 1-10 cm/second. This means that sensor output will have to be monitored milli- or micro-second precision. In order to reduce the amount of information sent from sensors to the decision core, it is convenient instead to generate and analyze descriptive parameters about the information, like the width and height of a sensor signal, rather than time-resolved information.

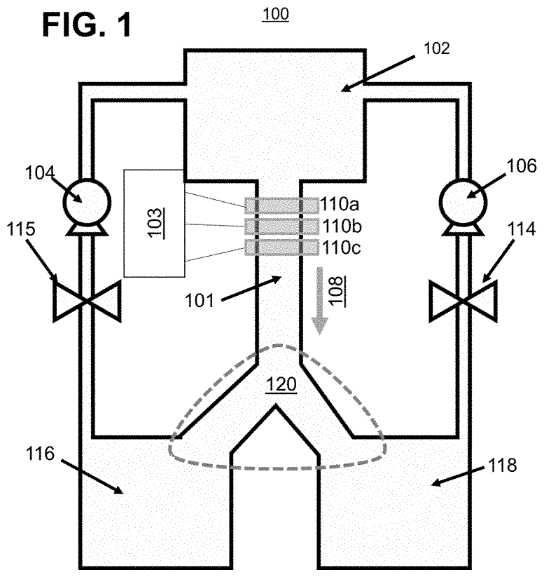

FIG. 1 illustrates a system 100 according to an embodiment. The system 100 may be filled with a fluid introduced in an input fluidic section 102. As configured, and with the fluid flowing in the input fluidic section 102, the system 100 is ready for sorting parts according to one or more modalities described below. The unsorted parts may flow with the fluid in the direction 108. The unsorted parts may be made of various materials. For example, and not by limitation, the unsorted parts may be pieces of a printed circuit board that has been broken apart to make the plurality of unsorted parts. In this configuration, the fluid will flow predominantly through either of the paths in the flow bifurcation at the junction 120.

As parts are introduced into the system 100 via the inlet manifold, they move with the fluid flow past a plurality of sensors (of which sensors 110a-110f are shown). The information collected by these sensors about each part is fed to a control system 103 that is communicatively coupled to the sensors 110a-110c. One of skill in the art will readily recognize that a communication link between the sensors 110a-110c and the control system 103 may be wireless, or a set of wired connections, or a combination of wired and wireless connections.

The control system 103, based on the information received from the sensors 110a-110c, may determine which of the bins 116 and 118 for parts flowing along 101 to route a first set of parts, the first set of parts being substantially the same (e.g., the same type of material). For example, in an exemplary use case, the control system 103 may be configured to actuate the pumps 104 and 106 as well as the valves 115 and 114, such that the first set of parts is routed to the bin 116 via a junction 120 or 132, which branches out the input fluidic sections 101 and 121 in two secondary channels. Specifically, in one implementation, in order to route the first set of parts to the bin 116, the control system 103 will issue a command to actuate one or more actuators (e.g., valves 106 or 114) to cause the first set of parts to flow towards the bin 116. A second set of parts may include unsorted parts or parts that are sorted according to another criterion established by the control system 103. In one implementation, the fluid may be pumped back to the fluidic section inlet manifold 102 so that it can be used to move other parts through the system 100. As such, the fluid is reusable.

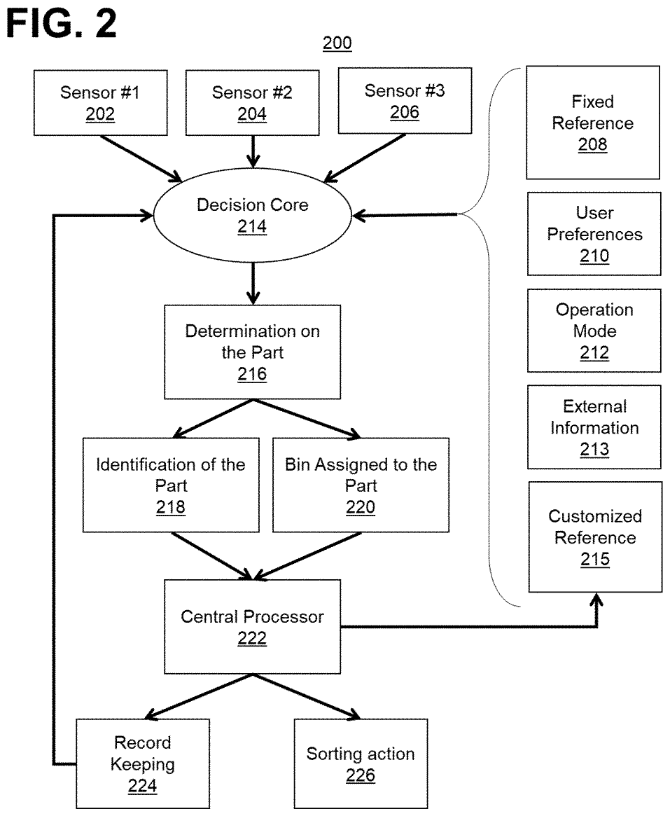

FIG. 2 illustrates a flowchart of a method 200 for utilizing the one or more of the various systems described herein. Where applicable, constitutive parts of the systems are described in the context of the method 200. Decision Core 214 receives information from multiple sensors 202, 204, and 206, and analyzes these signals in accordance to methods described herein in combination with information from external sources that include, without limitation, determining information from reference of materials applicable to systems similar to that being operated 208, determining information from customized reference of materials applicable only to this particular system 215, user preferences 210, mode of operation 212, and external information 213. User preferences 210 refers to weighting factors used in the determination that are readily customizable by a user and that adjust the operation of the system to better suit the needs of the user. Operation mode 212 refers to weighting factors or parameters considered in the determination. The decision core 214 uses the aforementioned information to make a determination about the part in 216. Determinations result primarily in two pieces of information: identification of the part 218 and the bin that is assigned to the part 220. In step 222 a central processor collects the determination related to the part, and stores the information for record keeping 224 in memory 402 and/or storage 420. Part of this information is also provided to the decision core 214 for use in determinations about future parts. The central processing unit also takes a sorting action 226 through that may manifest itself through the actuator/sensor interface 413 and leading to changes in the operation of valves 114 and 115, and pumps 104 and 106, that lead to the routing of the part to the bing assigned in 220. In specific circumstances, central processing unit may also refer to information about a part and associated determination to an individualized reference of materials 215. The circumstances include, without limitation, when a user specifies the identification of parts introduced into the system in order to expand the set of references the decision core has available for determinations.

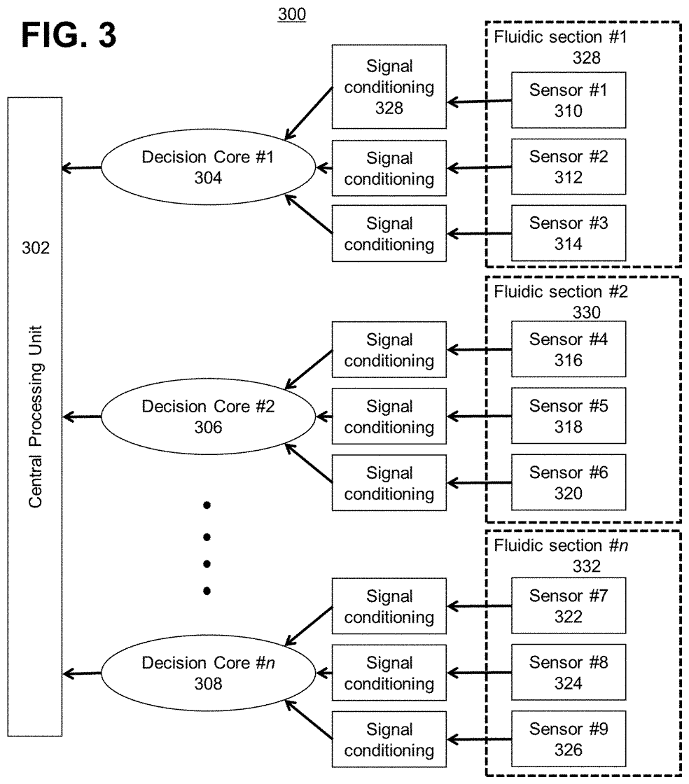

FIG. 3 illustrates a method for connecting sets of sensors associated with different fluidic sections. Sets of sensors in different fluidic sections 328, 330, or 332, work in parallel sensing parts that are common to sensors within each set but different between sets. Therefore, information from each set of sensors reach different decision cores 304, 306, or 308. Each decision core makes a determination separately from others. The determinations of all the decision cores reach the central processing unit for further action as illustrated in FIG. 2.

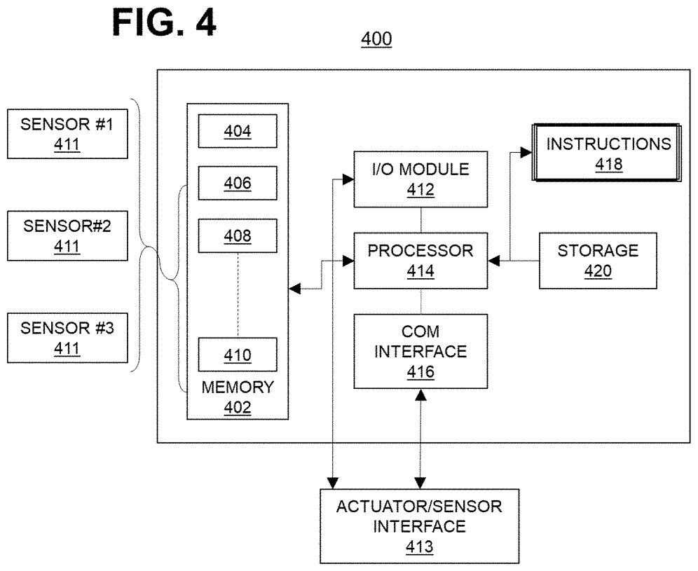

FIG. 4 illustrates a controller 400 (or system), according to the embodiments. The controller 400 may be configured by programmable instructions to implement the decision core 214, among other functionalities associated with the method 200 and the other aspects of the systems and assemblies described in FIGS. 1-3.

The controller 400 can include a processor 414 having a specific structure. The specific structure can be imparted to the processor 414 by instructions stored in a memory 402 and/or by instructions 418 fetchable by the processor 414 from a storage medium 420. The storage medium 420 may be co-located with the controller 400 as shown, or it can be remote and communicatively coupled to the controller 400. Such communications can be encrypted.

The controller 400 can be a stand-alone programmable system, or a programmable module included in a larger system. For example, the controller 400 can be included in the control system 103 described previously. The controller 400 may include one or more hardware and/or software components configured to fetch, decode, execute, store, analyze, distribute, evaluate, and/or categorize information. In the case that a system contains more than one group of sensors sharing a exclusive fluidic branch, such as sensors 110a-c sharing 101 in system 100, then the functions of decision core 214 associated with each group of sensors can be performed either by a dedicated controller 400 for each group of sensors, by a single controller 400, or a combination of shared and dedicated controllers.

The processor 414 may include one or more processing devices or cores (not shown). In some embodiments, the processor 414 may be a plurality of processors, each having either one or more cores. The processor 414 can execute instructions fetched from the memory 402, i.e. from one of memory modules 404, 406, 408, or 410. Alternatively, the instructions can be fetched from the storage medium 420, or from a remote device connected to the controller 400 via a communication interface 416. Furthermore, the communication interface 416 can also interface with an actuator/sensor interface 413, i.e., with electronic hardware that controls the flow rates, valves, and receive sensor data through the various parts of the above-described systems or assemblies of systems.

Without loss of generality, the storage medium 420 and/or the memory 402 can include a volatile or non-volatile, magnetic, semiconductor, tape, optical, removable, non-removable, read-only, random-access, or any type of non-transitory computer-readable computer medium. The storage medium 420 and/or the memory 402 may include programs and/or other information usable by processor 414. Furthermore, the storage medium 420 can be configured to log data processed, recorded, or collected during the operation of controller 400. The data may be time-stamped, location-stamped, cataloged, indexed, encrypted, and/or organized in a variety of ways consistent with data storage practice. By way of example, the memory modules 406 to 410 can form a sorting module 411 that includes instructions that, when executed by processor 714, cause processor 414 to perform certain operations consistent with the method 200 described above. The sorting module 411 may contain instructions that are fetched from an instruction set 418 and/or from one or more remote devices via an I/O module 412 and/or through the communication interface 416.

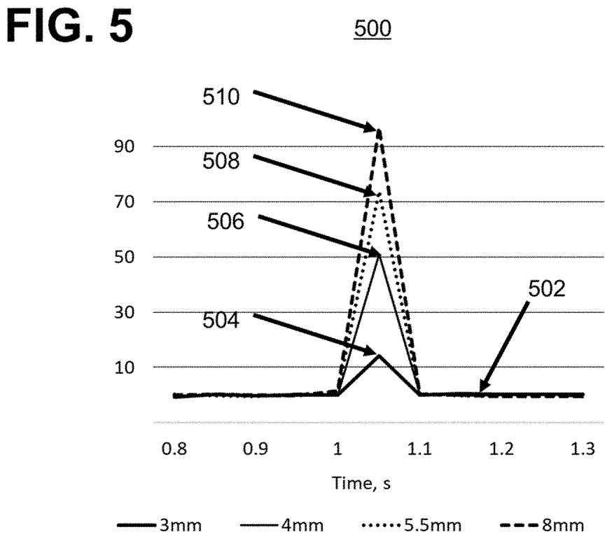

In FIG. 5, graph 500 shows the typical output of an electromagnetic sensor tuned to detect ferromagnetic metals as a function of time while a plurality of ferromagnetic parts of different size move through a fluidic section analogous to 101. The electromagnetic sensor is analogous to sensors 110a-110c, and typically, and without loss of generality, output a baseline value 502 in the absence of parts. As parts move through the apparatus the set of sensors provide outputs that are different from the baseline, and that are greater in for larger parts, with peak values 504, 506, 508, and 510 corresponding to parts 3, 4, 5.5, and 8 mm in diameter respectively.

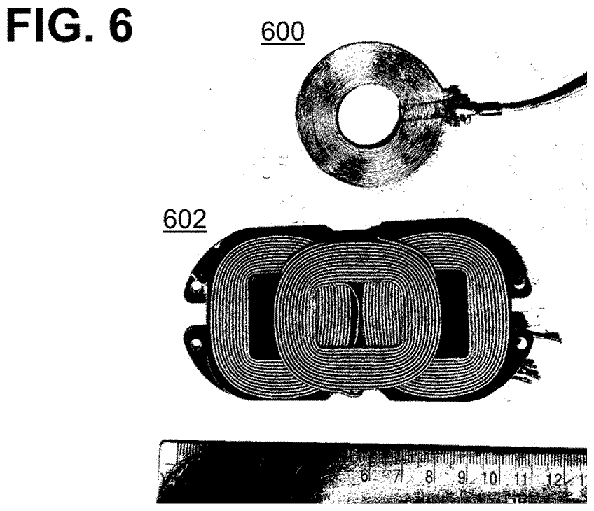

FIG. 6 shows a photograph of various coils used in the detection of ferrous and non-ferrous metals to produce the outputs presented in FIG. 5. 600 is a single detecting electromagnetic coil, while 602 is an assembly that combines multiple coils at a fixed and known configuration in order to supplement the information provided to the decision core 214.

FIG. 7 shows an illustration showing a photography of steel screw 702, moving in the direction 704, and the location of an electromagnetic sensor 706. 714 is a photograph of the output of electromagnetic sensor 706 as a function of time shortly after screw 702 crossed the region within which it senses. In 714 one can see that the sensor output increases from a baseline of 716 to 718, corresponding to the leading edge of the screw 708 entering the sensing region. Further, signal plateau 720 can be seen as section 710 of the screw travels through the sensing region, signal peak 720 can be seen as section 712 of the screw travels through the sensing region, and signal plateau 724 as screw 702 moves away from sensor 706.

FIG. 8 shows graph 800 which compares the output from optical sensors as a function of light reflecting on parts made of different materials as a function of light wavelength. Relative differences between two or more outputs corresponding to different wavelengths for a given part is exploited to characterize materials. For example and relative to output value 802, value 804 is lower for PET compared to the output of PP and HDPE at the same wavelength. Similarly, relative to output value 802, value 810 is higher for PET compared to the output of PP and HDPE at the same wavelength. Similarly, relative to output value 802, value 806 is lower for PP compared to the output of PET and HDPE at the same wavelength.

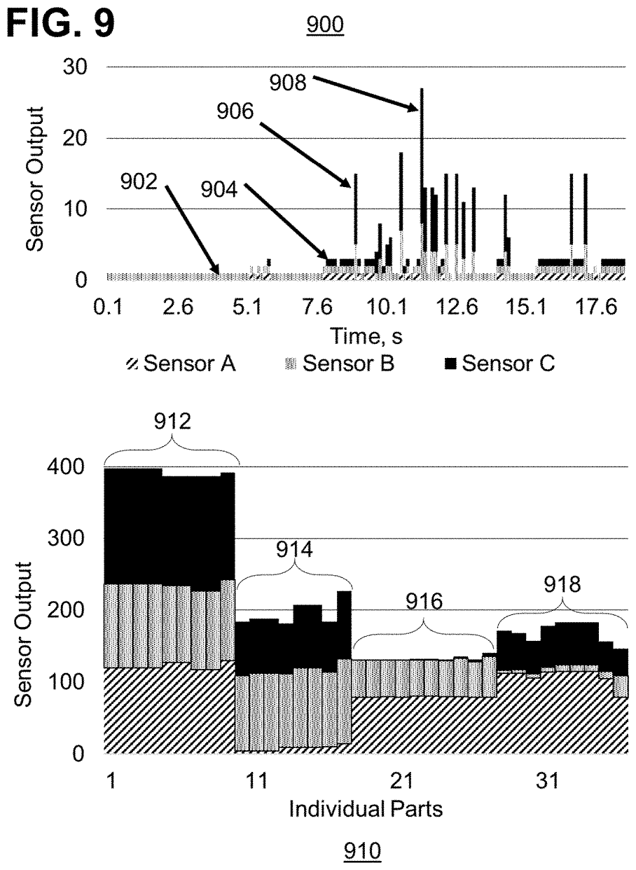

In FIG. 9, graph 900 shows the typical output of three optical sensors tuned to different wavelengths, A, B, and C, as a function of time while a plurality of parts, all of the same type, move through a fluidic section analogous to 101. Sensors A, B, and C, are analogous to sensors 110a-110c, and typically, and without loss of generality, output a baseline value 902 in the absence of parts. As parts move through the apparatus the set of sensors provide outputs that are different from the baseline, such as 906 and 908. The baseline may drift in value over time, producing spurious outputs, such as 904, that may need to be filtered or otherwise accounted for by the decision core 214. FIG. 9 also includes graph 910, which compares the output values by sensors A, B, and C in the vertical axis for different, individual, parts in the horizontal axis. Parts have been grouped as 912, 914, 916, and 918, according to type. The output of sensors A, B, and C, is expected to be similar for different parts of a given type. Variability in the absolute output value of sensors and the relative output between sensors for parts of a given type makes it necessary to process the information from sensors A, B, C, and other sensors operating on the same part according to the teachings in this disclosure.

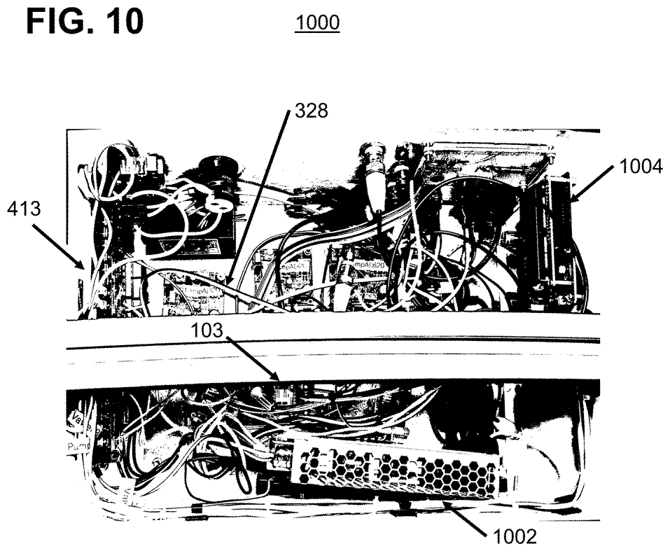

FIG. 10 shows a photograph of elements inside processing unit 103 of system 1200. Parts that are visible include control unit 400, actuator interface 413, signal conditioning modules 328, electrical power supply 1002, and electromagnetic excitation source 1004.

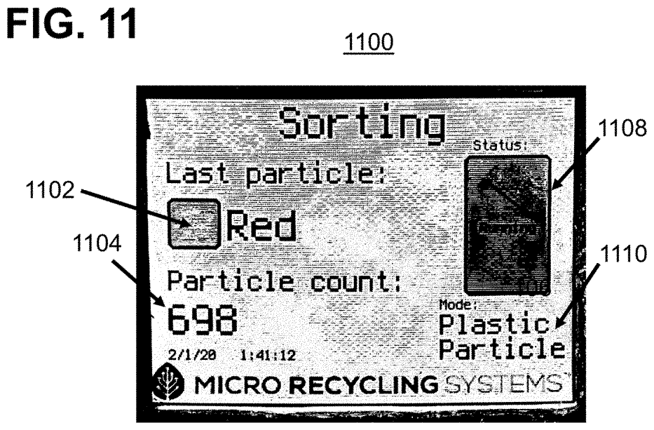

FIG. 11 shows a photograph of a display output produced by system 1200 as result of operation. The display output includes 1102 information about a recent determination 216, 1104 information about cumulative parts derived from past determinations included in 218, 1108 operational status of the system, and 1110 operational mode 212.

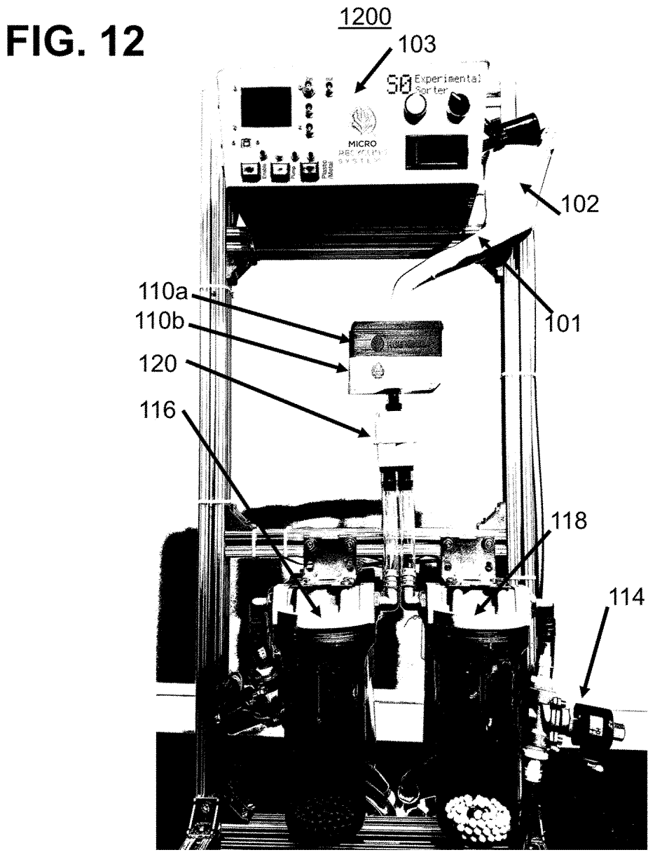

FIG. 12 shows a photograph of system 1200 which is an embodiment consistent with the teachings featured herein. Components readily visible include control system 103, the fluidic inlet 102, fluidic section 101, sensors 110a and 110b, junction 120, bins 116 and 118 (this embodiment is outfitted with two more bins not directly visible), and also control valve 114. This depiction of embodiment is not exhaustive, in that it does not show all of the elements disclosed and it is meant to communicate concrete exemplary embodiments without loss of generality.

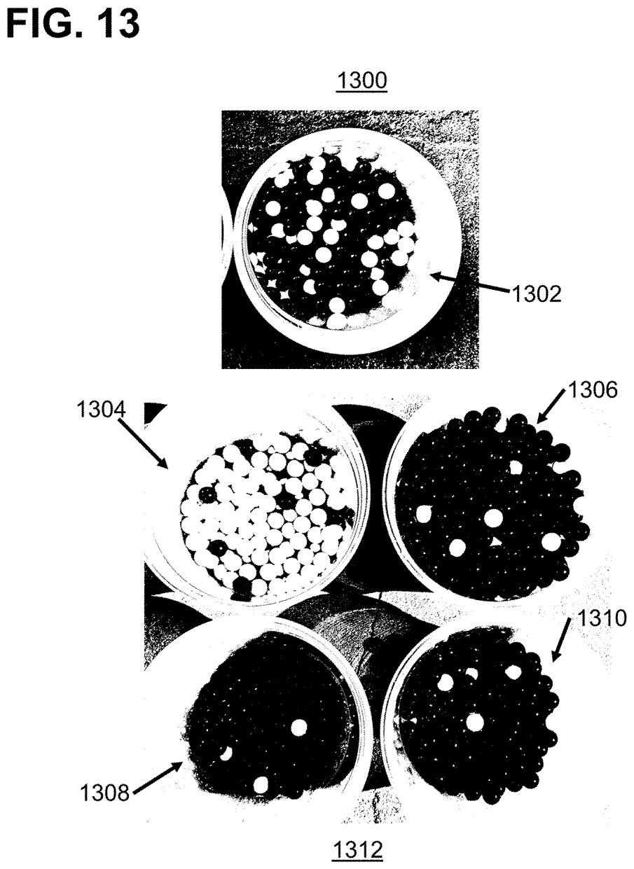

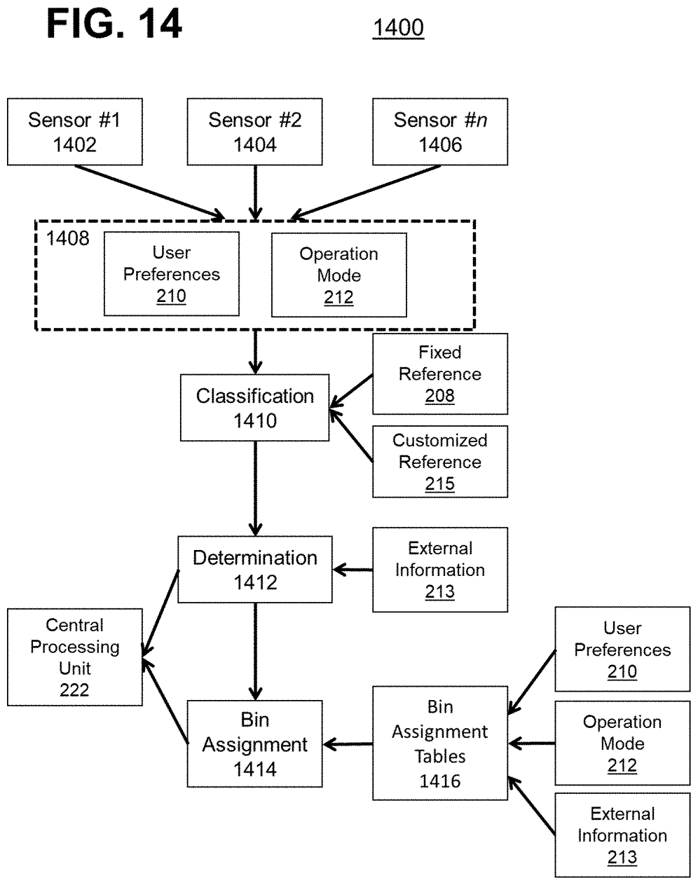

FIG. 13 shows two photographs. Photograph 1300 shows a batch of 4 different types of parts 1302 mixed together in roughly equal proportions, such that each type makes up roughly 25% of the total. Photograph 1312 shows these same parts after they were processed by system 1200 to separate them into 4 different portions, each portion enriched with a different type of part from the initial proportion of about 25% in 1300. Parts in portion 1204 were found to be 92% of a predominant type, parts in portion 1206 were found to be 98% of a different predominant type, parts in portion 1208 were found to be 89% of yet another different predominant type, and parts in portion 1210 were found to be 57% of yet another different predominant type.

FIG. 14 shows a diagram illustrating a method through which the decision core makes determinations. According to the methods described herein, the decision core gathers information {S₁, S₂ . . . Sₙ} collectively known as {S} from n different sensors (including 1402, 1404, and 1406), and connected via actuator/sensor interface 413. The values of {S} can be conditioned for readability through signal offset, amplification, analog-to-digital conversion and other common electronic instrumentation methods. In step 1408 the effect of user preferences 210 manifests as a set of weighting factors {a₁, a₂ . . . aₙ}, collectively known as {a}, while the effect of operation mode 212 manifests as a set of weighting factors {b₁, b₂ . . . bₙ}, collectively known as {b}. The weighted information from sensors {S·a·b} is the input to the classification step 1410.

Step 1410 is a classification step that uses sensor information {S·a·b} to determine the identity of a part from a set of possible identities defined by a fixed reference set 208 and a customized reference set 215 of information. There are several approaches to solving classification problems, including deterministic classification trees, principal component analysis, discriminant analysis, probabilistic classifier, neural networks and other forms of artificial intelligence. As an illustrative example of a classification in step 1410 and without limitation, a convenient method for identifying the part is to map {S·a·b} into a n-dimensional vectorial space and identify the reference with the greatest magnitude of the projection of vector {S·a·b} over the vector {S_{reference j}}, which represents sensor information for reference j. In step 1412 embodiments of the invention estimate characteristics, properties, economic value, or other continuous variables of interest about the part. This is done using information from the sensors {S·a·b} and external information 213. As an illustrative example of an estimation in step 1412 and without limitation, capacitance sensor information correlated with the volume of a part (by virtue of the water that the part displaces) is multiplied by the a density value stored in Fixed Reference 208 and corresponding to the material determined in step 1410, and by the market value of the material at that moment provided by External Information 213; as a result 1412 estimates the economic value of parts. Step 1412 outputs a set of information called a determination {D}, which is composed of the classification for the part according to the method employed in step 1410, information estimated about the part from step 1412, and other qualifying information from sensors {S·a·b} that may affect the sorting action 226.

In step 1414 {D} is compared against a bin assignment table to designate which bin the system routes the part. The bin assignment tables 1416 result from pre-defined parameters, including user preferences 210, operation mode 212, and external information 213. For example and without limitation, a given operation mode can focus on sorting parts according to type of plastic composition such that operational priority is to maximize the homogeneity of plastic types in each bin, and the corresponding sorting action look-up table instructs all non-plastic parts to be routed to a “waste” bin regardless of the identification of the part. In this situation she identification of parts made of extraordinarily valuable materials such as gold and routed to the waste bin can also be reported, per user preference, for subsequent retrieval. The example illustrates the value of knowing that a particular part is in a bin, even if the parts in the bin are heterogeneous.

Generally, an embodiment consistent with the teachings featured herein may include an apparatus, like the system 100, whose structural configuration allows low-volume, high-throughput, and high-fidelity sorting and/or separation operations. This exemplary apparatus may include a fluidic section that comprises an input section. The fluidic section may be configured to receive a fluid including a plurality of parts at the input section. For example, and not by limitation, the fluidic section may be configured to receive the fluid at an inlet port of the fluidic section. The fluidic section may include at least two branches extending from the input section, and each of these at least two branches may have an outlet through which the fluid or part of the fluid may be routed. The apparatus may include a set of sensors configured to capture information about the plurality of parts in the fluidic section. The sensors are configured to operate on a predetermined number of parts traveling at any given time along a section of the fluidic channel. The predetermined number of parts is smaller than the maximum number of parts physically or practically able to fit in the fluidic section. A given number of parts is preferred as predetermined when it is higher, and not so high that the ability of separating the parts, if desired, is lost and that the information from the sensors loses relevance and actionability. The apparatus may further include a set of actuators configured to effect, based on the information, a change in a movement of a set of parts from the plurality of parts such that the set of parts is distributed via the fluid to at least one of the at least two branches.

In the embodiment, a specified part from the set of parts, one (or generally a subset of parts) of the set of parts can include a metal, while another part (or generally another non-overlapping subset) can include non-metallic parts. The embodiment may be configured to allow low-volume sorting and/or low-volume separations. For example, the apparatus may be configured with a volume of fluid, taken from an inlet of the input section to an outlet of one of the at least two branches, of less than about 10 liters. Generally, this may yield a throughput of sorted parts of less than about 400 lbs./hr.

Furthermore, in the exemplary apparatus, the set of actuators can include an actuator selected that is either a valve, a pin, or a jet of secondary fluid. Generally, without limitation, the set actuators may be actuators that are all the same or they may be a set of different actuators. In the case of a jet fluid actuator, the fluidic section may include side ports through which a jet of secondary fluid may be forcibly introduced in the fluid (here the primary fluid) in order to effect a change in the trajectory of the plurality of parts. In this case, the jet of secondary of secondary fluid may be either a liquid or a gas.

The apparatus can further include a set of sensors. Without limitation, but by example only, the set of sensors may include an electromagnetic sensor, a mechanical sensor, an acoustic sensor, a radiation sensor, or an optical sensor. One of ordinary skill in the art will readily recognize that all of the sensors in the set may be of one type or that the set of sensors may be the combination of several types of sensor; in the latter case, several sensing modalities can be used, without departing from the scope of the present disclosure.

In the case of an electromagnetic sensor, the sensor may be configured to capture information about the complex formed by the fluid and the parts located therein based on a single operating frequency. Without limitation, but by example, this single frequency may be about 10 kilohertz (kHz). In an alternate embodiment, the electromagnetic sensor may be configured to capture the information using a plurality of operating frequencies. For example, and not by limitation, the sensor may be configured to operate at frequencies of about 100 Hz, 10 kHz, and 1 MHz. One of skill in the art will readily recognize that generally, two or more frequencies can be used, without departing from the scope of the present disclosure. In addition, the part will give different responses to electromagnetic fields along different orientations, depending on the part's composition and distribution of this composition. For this purpose, it is valuable to use electromagnetic excitation sources and sensors aligned along multiple directions, preferably orthogonal to one another, since they can give insight on the identity of the particle. For example, a motor winding core, made of steel rich in silicon and undesirable for mixing with other types of steel, gives a very different electromagnetic signature along different axis as a result of its laminated composition; whereas a part made of solid steel, suitable for mixing with other types of steel, will have similar electromagnetic signatures along different axis, as a result of a solid and isotropic composition.

In the case of a mechanical sensor, the sensor may be configured to detect a force or displacement. In the case of an acoustic sensor, the sensor may be configured to detect ultrasounds. In the case of an optical sensor, the information captured may be based either a reflectance, an absorbance, a transmittance, a fluorescence, a diffraction, or a scattering profile. In alternate embodiment, a combination of one or more or of all these modalities may be used without departing from the scope of the present disclosure. In the case of a radiation sensor, the sensor may be an X-Ray detector, and the information captured may be based on detecting an X-Ray having an energy in the range of about 1 keV to about 100 keV. In yet another alternate embodiment, the range of the detected X-Ray may be in the range of about 1 keV to about 10 keV.

In order to increase the overall speed of processing parts it is convenient for systems to have multiple fluidic sections that work in parallel to each other and route the parts to the same or different bins as the other fluidic sections. In such cases, multiple sensors of the same or different types are used in parallel such that information is captured in all of the fluidic sections employed. Information from sensors within each fluidic section is combined in the same way as described previously in order to make a determination about the parts under analysis. The information can also be shared across fluidic sections in order to provide a broader view of the parts being sorted and change operation strategies for a more efficient use of the system. For example, sensors in one fluidic section detect the presence of gold and this information leads to changing a threshold of sensitivity for the determination of gold in other fluidic sections in ways comparable external information.

One scenario where the invention is useful is in assisting in blending fractions of particular interest. For example, when intending to use post-consumer clear PET bottles for recycling into new clear PET bottles. In this situation, an abundance of green-clear PET bottle scrap in a batch of clear PET scrap can stifle the batch's value because the hue of the resulting material will shift undesirably to green. This effect can be counteracted by the right proportion of blue-clear PET bottle scrap. The invention described herein can be used to keep track of the amount of clear, clear-green, and clear-blue in a particular bin, and redirect incoming clear-green scrap once it reaches a predetermined proportion relative to clear and clear-blue scrap. Parts from other materials, such as HDPE, can similarly be mixed purposely to have a particular hue (e.g., following instructions to blend orange, the system would mix yellow and red HDPE). The invention reports the properties of each part, or aggregated values (i.e., per batch, per unit time).

Lastly, although the drawings describe operations in a specific order and/or show specific arrangements of components and are described in the context of recycling, separating particles, or extracting specific materials from a plurality of parts, one should not interpret that a specific order and/or arrangements of the components and/or steps of described methods limit the scope of the present disclosure, or that all the operations performed and the components disclosed are needed to obtain a desired result.

What is claimed is:

1. An apparatus, comprising:
a fluidic section including an input section, the fluidic section being configured to receive a fluid including a plurality of parts therein, the fluidic section further including at least two branches extending from the input section;
a set of sensors configured to capture information over about the plurality of parts in the fluidic section;
a processing unit that combines the information from the set of sensors in order to make a determination about the plurality of parts, and
a set of actuators configured to effect, based on the determination, a change in a movement of a set of parts from the plurality of parts such that the set of parts is distributed via the fluid to at least one of the at least two branches;
wherein the path in which the set of parts move is enclosed such that fewer than a predetermined number of parts can enter the volume in space from which the sensors gather information.

2. The apparatus of claim 1, wherein one or more sensors from the set of sensors are configured to utilize signals in the electromagnetic spectrum ranging in wavelength from about 10⁵ to about 10⁻¹² m.

3. The apparatus of claim 2, wherein the one or more sensors are configured to gather directional information about the part.

4. The apparatus of claim 1, wherein one or more sensors from the set of sensors are configured to utilize signals in the electromagnetic spectrum ranging in wavelength from about 280 nm to 3,000 nm.

5. The apparatus of claim 1, wherein one or more sensors from the set of sensors are configured to utilize signals in the electromagnetic spectrum ranging in frequency from about 10³ to 10¹⁰ Hz.

6. The apparatus of claim 1, wherein one or more sensors from the set of sensors are configured to utilize signals in the electromagnetic spectrum ranging in photon energy from about 10³ to about 10⁵ eV.

7. The apparatus of claim 1, further including a processor configured to receive information from one or more sensors from the set of sensors, the processor further being configured to receive instructions from a memory which when executed configure the processor to perform operations including classification of specified parts from the plurality of parts that are not recognizable from the outputs of one or more sensors from the set of sensors.

8. The apparatus of claim 1, further including a processor configured to receive information from one or more sensors from the set of sensors, the processor further being configured to receive instructions from a memory which when executed configure the processor to perform operations including determining the economic value of the parts.

9. The apparatus of claim 7, wherein the operations further include predicting characteristics of the aggregate of the parts.

10. The apparatus of claim 1, where the time-varying signals gathered from the sensors is mapped from the time-domain to the space-domain in order to reflect differences in elemental composition in the direction parallel to the flow; thereby forming 2D or 3D maps of spatial composition variations of the parts.

11. The apparatus of claim 7, wherein the processor is configured to use directional information provided from one or more sensors from the set of sensors, the one or more sensors being laid in multiple orientations within the apparatus.

12. The apparatus of claim 1, wherein the parts are smaller than 2.5 cm.

13. The apparatus of claim 1, wherein the parts include plastic.

14. The apparatus of claim 1, wherein the parts include a metal.

15. The apparatus of claim 1, include plastic and a metal.
